(19) United States
(12) Patent Application Publication
(10) Pub. No.: US 2004/0159368 A1
(43) Pub. Date: Aug. 19, 2004

(54) Quick fill cap for a toy water gun

(76) Inventors: Fred D. Eddins, Mapleville, RI (US); Robert L. Brown, North Kingstown, RI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/361,916

(22) Filed: Feb. 10, 2003

(51) Int. Cl. B67C 11/04

(52) U.S. Cl. 141/340

(57) ABSTRACT

The present invention is directed to a quick fill cap for a toy gun capable of discharging an output stream of liquid. The toy gun may have a liquid reservoir for storing a quantity of liquid and fill port for depositing liquid in to the liquid reservoir. The quick fill cap may include a cap portion having a throughbore, wherein the cap portion may be adapted to demountably attach to the fill port of the toy gun and to form a substantially airtight and watertight seal with the fill port. The quick fill cap may further include a hollow funnel having a lower surface connected to an upper surface of the cap portion such that a substantially airtight and watertight seal is formed between the lower surface of the hollow funnel and the upper surface of the cap portion. The hollow funnel may be substantially aligned with the throughbore of the cap, and the hollow funnel may be disposed external to the liquid reservoir when the cap portion is demountably attached to the fill port. Still further, the quick fill cap may include a one-way valve connected to the cap portion proximate an opening of the throughbore opposite the hollow funnel. The one-way valve may be disposed on the interior of the liquid reservoir when the cap portion is demountably attached to the fill port, and the one-way valve may be adapted to allow liquid to flow from the exterior of the liquid reservoir through the channel formed by the hollow funnel and the throughbore of the cap portion and into the reservoir. The one-way valve may further be adapted to prevent liquid from flowing from the interior of the liquid reservoir through the channel formed by the throughbore of the cap portion and the hollow funnel to the exterior of the reservoir.

### BACKGROUND OF THE INVENTION

The present invention is directed to a toy water gun, and more particularly to a quick fill cap for a toy water gun that may facilitate filling a tank of the toy water gun with a liquid without removing the quick fill cap, and that may further prevent leakage of liquid disposed within the tank when the toy water gun is inverted or otherwise positioned with the liquid bearing against the quick fill cap.

Various toy water guns wherein a one-way valve is implemented to regulate the flow of the liquid disposed therein have been previously described. For example, U.S. Pat. No. 6,234,347 to Amron discloses a toy water gun operable in accordance with two distinct modes of operation. In a first mode of operation, the toy water gun receives and stores pressurized water directly from a municipal water supply. This is achieved using an adaptor which allows water to flow under pressure into a reservoir of the gun such that the user needs only to press a trigger to cause water to eject through the nozzle of the gun. In a second mode of operation, a fill cap or other opening is exposed so that unpressurized water may be poured in or otherwise received into the gun. A manually operable pump is included so that the unpressurized water may be pressurized where upon depression of the trigger will cause the water to be ejected from the gun. An adapter includes a one-way valve assembly connected to an end of a tube such that pressurized water available from a municipal water supply may be introduced into the tube and thereafter into a reservoir. The one-way valve will permit the liquid to flow freely in one direction into the reservoir, and prevents the liquid from flowing in the opposition direction.

U.S. Pat. No. 5,141,132 to Whelan discloses a water pistol which includes an elongated, flexible tube removably connectable to the grip of the pistol. The tube receives water under pressure directed through the body of the pistol from an inlet port located at the rear or butt end of the pistol. The pistol also serves to force the discharged water through a front nozzle of the pistol when the user pulls a trigger. A fill port includes a fill check valve and O-ring that serves to prevent the back flow of water from a tube through the fill port. The positioning of the check valve is guided by the seat provided within a chamber formed in an upper body portion of the water pistol.

### SUMMARY OF THE INVENTION

In one aspect, the invention is directed to a quick fill cap for a toy gun capable of discharging an output stream of liquid. The toy gun may have a liquid reservoir for storing a quantity of liquid and fill port for depositing liquid in to the liquid reservoir. The quick fill cap may include a cap portion having a throughbore, wherein the cap portion may be adapted to demountably attach to the fill port of the toy gun and to form a substantially airtight and watertight seal with the fill port. The quick fill cap may further include a hollow funnel having a lower surface connected to an upper surface of the cap portion such that a substantially airtight and watertight seal is formed between the lower surface of the hollow funnel and the upper surface of the cap portion. The hollow funnel may be substantially aligned with the throughbore of the cap, and the hollow funnel may be disposed external to the liquid reservoir when the cap portion is demountably attached to the fill port. Still further, the quick fill cap may include a one-way valve connected to the cap portion proximate an opening of the throughbore opposite the hollow funnel. The one-way valve may be disposed on the interior of the liquid reservoir when the cap portion is demountably attached to the fill port, and the one-way valve may be adapted to allow liquid to flow from the exterior of the liquid reservoir through the channel formed by the hollow funnel and the throughbore of th& cap portion and into the reservoir. The one-way valve may further be adapted to prevent liquid from flowing from the interior of the liquid reservoir through the channel formed by the throughbore of the cap portion and the hollow funnel to the exterior of the reservoir.

In another aspect, the invention is directed to a quick fill cap for a toy gun capable of discharging an output stream of liquid. The toy gun may have a liquid reservoir for storing a quantity of liquid and fill port for depositing liquid in to the liquid reservoir. The quick fill cap may include a cap portion having a throughbore, wherein the cap portion may be adapted to demountably attach to the fill port of the toy gun and to form a substantially airtight and watertight seal with the fill port. The quick fill cap may further include a hollow funnel having a lower surface connected to an upper surface of the cap portion such that a substantially airtight and watertight seal is formed between the lower surface of the hollow funnel and the upper surface of the cap portion. The hollow funnel may be substantially aligned with the throughbore of the cap, and the hollow funnel may be disposed external to the liquid reservoir when the cap portion is demountably attached to the fill port.

Still further, the quick fill cap may include a one-way valve connected to the cap portion proximate an opening of the throughbore opposite the hollow funnel. The one-way valve may be disposed on the interior of the liquid reservoir when the cap portion is demountably attached to the fill port, and the one-way valve may be adapted to allow liquid to flow from the exterior of the liquid reservoir through the channel formed by the hollow funnel and the throughbore of the cap portion and into the reservoir. The one-way valve may further be adapted to prevent liquid from flowing from the interior of the liquid reservoir through the channel formed by the throughbore of the cap portion and the hollow funnel to the exterior of the reservoir. In addition, the quick fill cap may include an air release valve having a first opening placing the air release valve in fluid communication with the interior of the liquid reservoir when the cap portion is demountably attached to the fill port and a second opening placing the air release valve in fluid communication with the atmosphere external to the liquid reservoir. The air release valve may be open such that air disposed within the liquid reservoir is in fluid communication with the atmosphere external to the liquid reservoir when the toy gun and quick fill cap are disposed in an upright position, and may be closed to prevent air and water disposed within the liquid reservoir from being communicated to atmosphere external to the liquid reservoir when the toy gun and quick fill cap are disposed in an inverted position.

Addition aspects of the invention are defined by the claims of this patent.

### BRIEF DESCRIPTION OF THE DRAWINGS

FIG. 1 is a side view of a toy water gun having an embodiment of a quick fill cap attached to a fill port;

FIG. 2 is a side perspective view of the quick fill cap of FIG. 1;

FIG. 3 is a side exploded view of the quick fill cap of FIG. 1;

FIG. 4 is a partial side sectional view of the toy water gun and quick fill cap of FIG. 1 being engaged by a hose or faucet outlet;

FIG. 5 is a partial side sectional view of the toy water gun and quick fill cap of FIG. 1 in an inverted position;

FIG. 6 is a side perspective view of another embodiment of a quick fill cap;

FIG. 7 is a side exploded view of the quick fill cap of FIG. 6;

FIG. 8 is a partial side sectional view of a toy water gun and the quick fill cap of FIG. 6 being engaged by a hose or faucet outlet; and

FIG. 9 is a partial side sectional view of a toy water gun and the quick fill cap of FIG. 6 in an inverted position.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

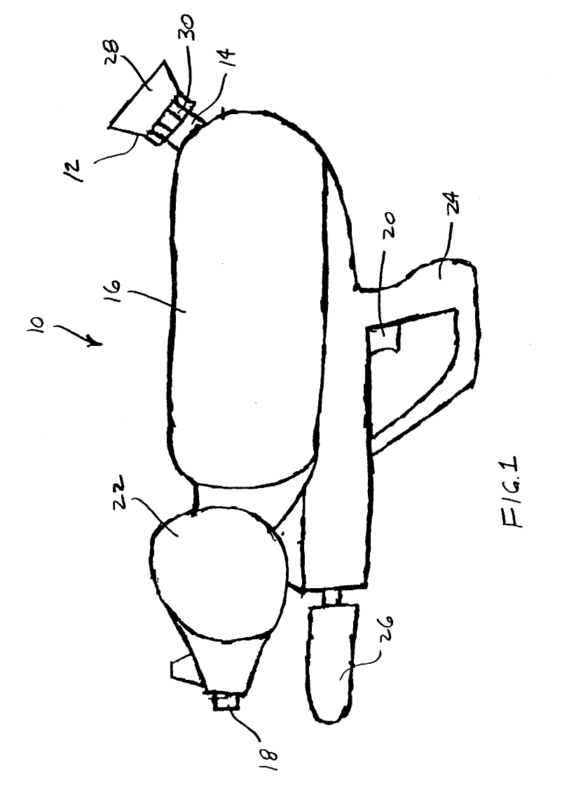

FIG. 1 illustrates a toy water gun 10 having a quick fill cap 12 removably attached to a fill port 14 of a tank or reservoir 16. The toy water gun 10 may be a pressurized toy water squirt gun that uses a self-contained pressurizing mechanism to pressurize a reservoir, such as the tank 16, to create a pressure differential between the reservoir and the ambient atmosphere such that the liquid contained therein may be propelled from the toy as an output stream of liquid discharged from a nozzle, such as nozzle 18. One example of a pressurizing mechanism that may be disposed within the toy water gun 10 is disclosed in U.S. Pat. No. 5,305,919, entitled “Pinch Trigger Hand Pump Water Gun with Non-Detachable Tank,” which issued on Apr. 26, 1994, and which is expressly incorporated herein by reference in its entirety. Of course, other pressurizing mechanisms are well-known in the art and may be implemented in the toy water gun 10 having the quick fill cap 12. Alternatively, the toy water gun 10 may be a toy squirt gun of the type having a trigger 20 integrated with a pump disposed within the toy water gun 10 such that pulling the trigger 20 may operate the pump to supply pressure causing an output stream of liquid at the nozzle 18. One example of a toy squirt gun having an integrated trigger and pump is disclosed in U.S. Pat. No. 4,334,383, entitled “Water Sprinkling Toy Pistol with Bubble-Blowing Ring,” which issued on Jun. 15, 1982, and which is expressly incorporated herein by reference in its entirety. Of course, other mechanical and electro mechanical mechanisms for causing an output stream of liquid from a nozzle of a toy water gun are well known in the art and are contemplated as having use in the toy water gun 10 utilizing the quick fill cap 12.

As previously discussed the toy water gun 10 includes a tank 16 that may have a quantity of liquid disposed therein that may be discharged in an output stream from the nozzle 18 when the trigger 20 is activated by the user. The toy water gun 10 may include a housing 22 supporting the tank 16 and enclosing the discharge mechanism of the toy water gun 10, and having a handle 24 dispose proximate the trigger 20 which may be grasped by the user when using the toy water gun 10. If a pressurizing mechanism as previously described is implemented in the toy water gun 10, the toy water gun 10 may further include a pump handle 26 extending from the housing 22 that may allow the user to pump a piston or other mechanism to pressurize the liquid disposed within the tank 16.

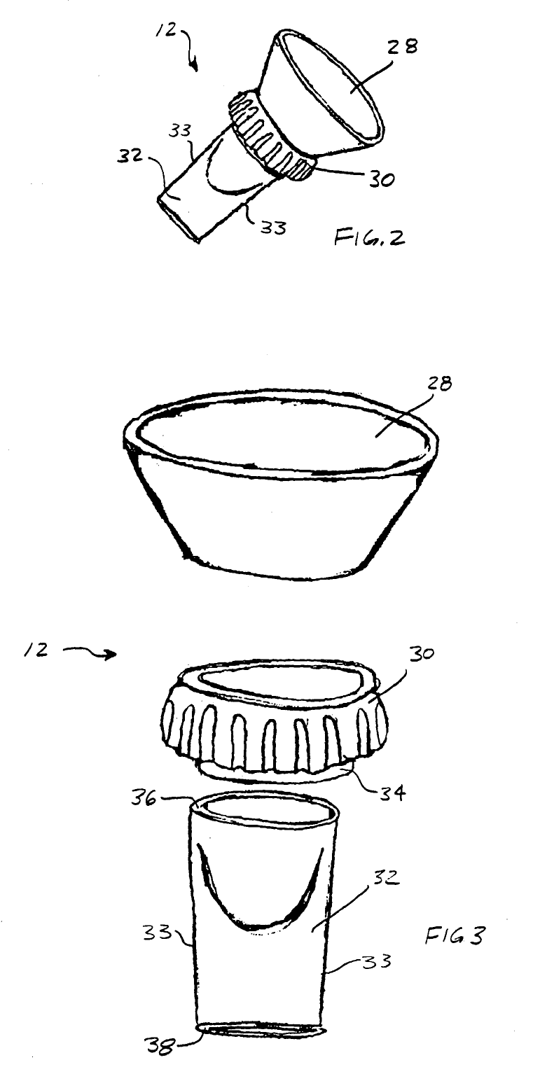

The quick fill cap 12 detachably connected to the fill port 14 may include an external funnel 28 and cap portion 30 that may be engaged by the user to attach and detach the quick fill cap 12 at the fill port 14. The funnel may be tapered, shaped as a truncated cone or otherwise configured to receive an outlet capable of discharging a stream of liquid. The cap portion 30 may also include a throughbore aligning with an open end of the funnel 28 to form a continuous channel when the funnel 28 is attached to the cap portion 30. Referring to FIG. 2, an embodiment of the quick fill cap 12 may further include a one-way valve 34 that may be connected to the cap portion 30 such that the one-way valve 34 may be disposed within the tank 16 when the quick fill cap 12 is attached to the fill port 14. In the illustrated embodiment, the one-way valve 34 may be a duck bill valve that may be implemented as a sleeve formed from an elastomeric material, such as rubber, and having diametrically opposed creases 33 such that the sleeve may be substantially flat when not attached to the cap portion 30 with diametrically opposed portions of the sleeve being in contact or being disposed in close proximity.

As illustrated in FIG. 3, the cap portion 30 may further include a downwardly extending hollow stem 34, which may be tapered, and on to which an open end 36 of the sleeve may be disposed. The open end 36 of the sleeve and the stem 34 may be dimensioned such that the open end 36 engages the outer surface of the stem 34 to create a substantially airtight and watertight seal and form a continuous channel through the hollow cap portion 30 and one-way valve 32. Alternatively, the open end 36 may be secured to the exterior surface of the stem 34 by an adhesive disposed between the open end 36 and the stem 34, a taught band around the exterior of the open end 36 at the stem 34, or by any other mechanism for securing the open end 36 to the stem 34 to form a substantially airtight and watertight seal. When the sleeve is disposed on the stem 34, the end 38 of the sleeve opposite the open end 36 may be substantially closed due to the generally flat configuration of the sleeve caused by the diametrically opposed creases 33. In this configuration, the closed end 38 may allow fluid poured through the openings of the funnel 28 and cap portion 30 to flow out of the closed end 38 while also being capable of forming a substantially watertight seal at the closed end 38 to prevent liquid from flowing into the quick fill cap 12 in the opposite direction. While the one-way valve 32 is illustrated and described herein as being a duck bill-type valve, it would be understood by those skilled in the art that the one-way valve 32 may be any conventional one-way or check valve, such as a ball or flat valve or the like, which will permit the liquid to flow freely in one direction, such as through the funnel 28, cap portion 30 and one-way valve 32, and out the closed end 38, and which prevents the liquid from flowing in the opposite direction.

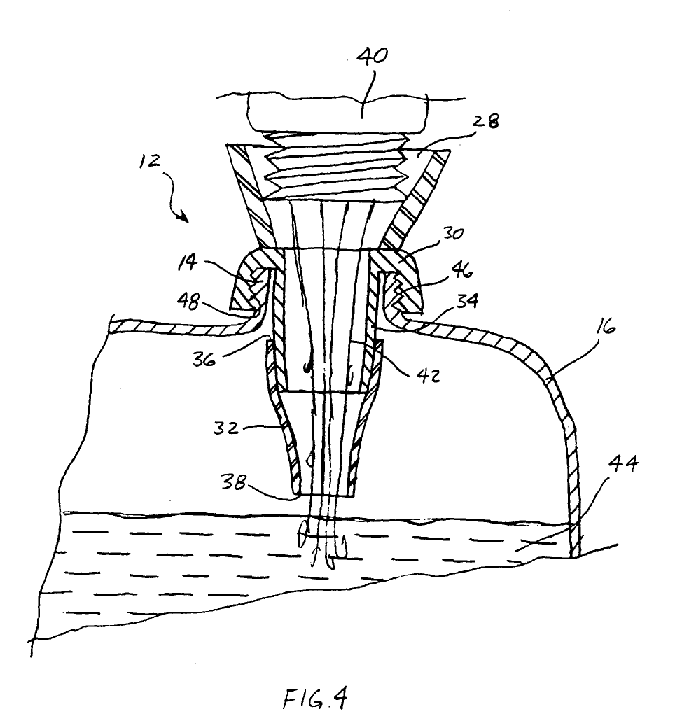

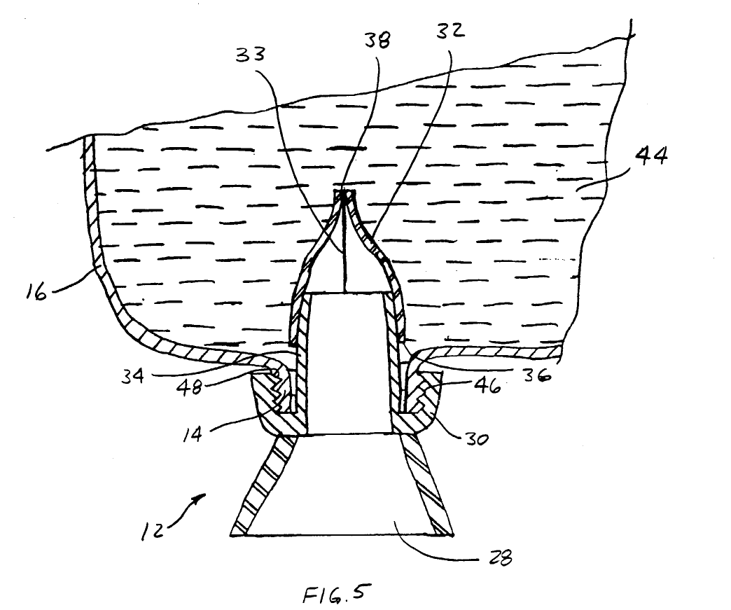

Referring now to FIG. 4, the quick fill cap 12 may be connected to the fill port 14 so that an outlet 40 of a hose, faucet, watering can, or the like, may discharge an output stream of liquid 42 through the quick fill cap 12 and into the tank 16 to form an accumulated amount of liquid 44. In the illustrated embodiment, the cap portion 30 may have a threaded inner surface 46 configured to engage and mate with a corresponding threaded outer surface 48 of the fill port 14 such that a substantially airtight and watertight seal is formed when the cap portion 30 is screwed onto the fill port 14 with a sufficient amount of torque. Of course, other mechanisms for connecting the quick fill cap 12 to the fill port 14 to form a substantially airtight and watertight seal are well known and are contemplated as having use with the quick fill cap. The funnel 28 may be configured to receive outlets 40 having varying outer diameters such that the outer surface of the outlet 40 may, if desired, engage the inner surface of the funnel 28. The funnel 28 may be fabricated from a resilient or semi-resilient material, such as rubber, so that a substantially watertight seal may be formed between the engaged outer surface of the outlet 40 and inner surface of the funnel 28. The funnel 28 may be connected to the cap portion 30 by an adhesive or other connection mechanism by which a substantially watertight seal is formed between the engage surfaces of the funnel 28 and cap portion 30. Alternatively, the funnel 28 and cap portion 30 may be fabricated as a single unitary component from a single piece of material. Moreover, the one-way valve 32 may also be integrally formed with the stem 34 as a single unitary component.

As shown in the figure, when the outlet 40 is disposed within the funnel 28, an output stream of liquid 42 may be discharged from the outlet 40 through the continuous channel form by the funnel 28, the cap portion 30 and the one-way valve 32. The force of the output stream of liquid 42 on the inner surface of the one-way valve 32 may be sufficient to cause the open end 38 of the one-way valve 32 to open, thereby allowing the output stream of liquid 42 to flow into the tank 16 and increase the accumulated amount of liquid 44. When the outlet 44 is removed from the funnel 28 or the output stream of liquid 42 is otherwise discontinued, thereby eliminating the force of the output stream of liquid 42 against the inner surface of the one-way valve 32, the restorative force of the resilient material from which the one-way valve 32 is fabricated causes the one-way valve 32 proximate the closed end 38 to flatten and thereby cause the diametrically opposed portions of the inner surface of the one-way valve 32 to again be engaged or disposed in close proximity to prevent the accumulated liquid 44 from flowing into the quick fill cap 12 through the closed end 38 as discussed hereinafter.

Once the output stream of liquid 42 is discontinued, the one-way valve 32 of the quick fill cap 12 may prevent the accumulated liquid 44 from flowing out through the fill port 14 as long as the quick fill cap 12 is disposed thereon. For example, FIG. 5 illustrates the portion of the tank 16 proximate the fill port 14 when the toy water gun 10 is inverted. As the toy water gun 10 is inverted and the liquid 44 accumulates at the fill port 14, the seal between the cap portion 30 and the fill port 14 prevents the liquid 44 from leaking out between the threaded inner surface 46 and threaded outer surface 48. At the closed end 38 of the one-way valve 32, the force exerted by the accumulated liquid 44 on the outer surface of the valve 32 increases the sealing force at the closed end 38 to prevent leakage of the accumulated liquid 44 through the closed end 38. Similarly, the force of the accumulated liquid 44 bearing on the outer surface of the sleeve proximate the open end 36 increases the sealing force between the open end 36 and the stem 34. As a result, the accumulated liquid 44 is retained in the tank 16 as the quick fill cap 12 prevents the accumulated liquid 44 from flowing out of the tank 16 through the fill port 14.

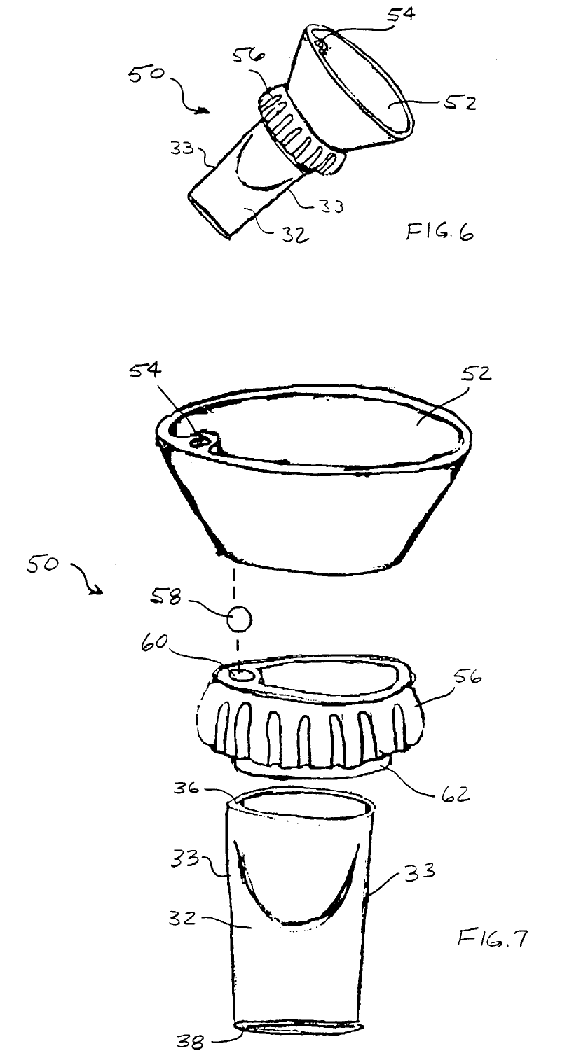

In some implementations, it may be desirable to prevent the excessive buildup of pressure within the tank 16 as liquid is discharged into the tank 16 by the outlet 40. In such implantations, it may be desirable to adapt a quick fill cap to allow air to escape from the tank 16 as the tank 16 is being filled with liquid, while still preventing the accumulated liquid 14 from flowing out of the tank 16 through the fill port 14 while the quick fill cap is attached thereto. FIGS. 6 and 7 illustrate one embodiment of a quick fill cap 50 that may facilitate the release of air from the tank 16 as the tank 16 is being filled by liquid discharged from the outlet 40. The quick fill cap 50 may include a funnel 52 having a vent 54 integrally formed therein to facilitate release of air from the tank 16. The quick fill cap 50 may further include a cap portion 56 having a ball 58 disposed within a cavity 60 formed in the cap portion 56 and stem 62, thereby forming a ball valve that may allow air to be discharged from the tank 16 while sealing the tank 16 to prevent the accumulated liquid 44 from flowing out of the fill port 14 while the quick fill cap 50 is attached thereto.

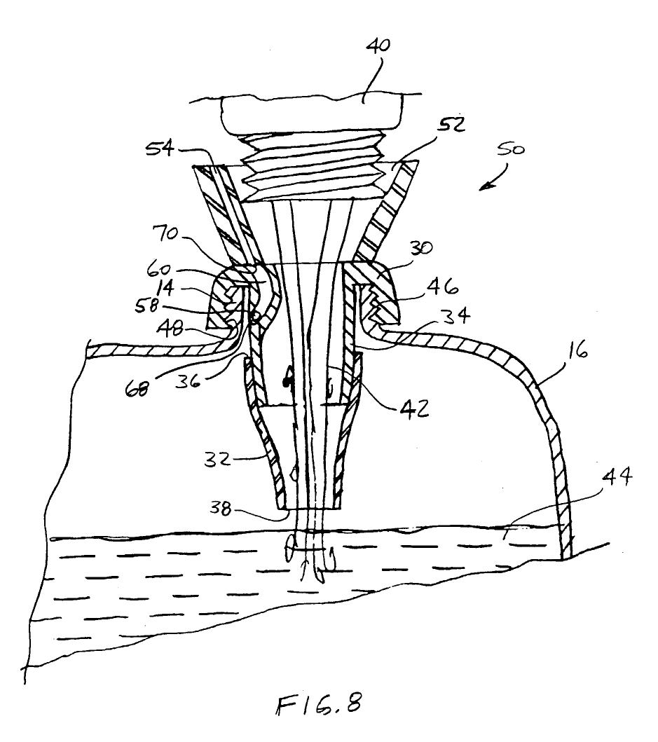

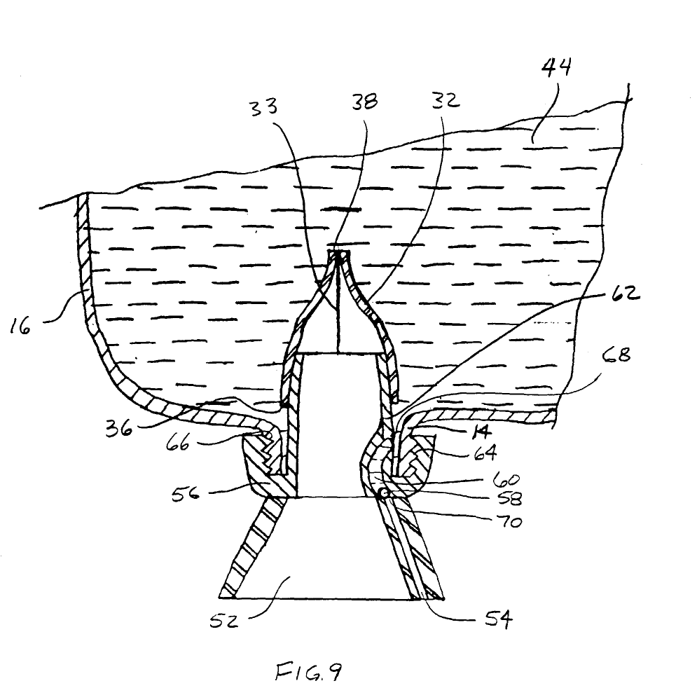

Referring to FIG. 8, the quick fill cap 50 is illustrated with the outlet 40 discharging an output stream of liquid 42 through the quick fill cap 50 to increase the amount of accumulated liquid 44. As discussed with the previous embodiment, the cap portion 56 may include a threaded inner surface mating with a threaded outer surface 66 of the fill port 14. The cavity 16 may be integrally or otherwise formed within the cap portion 56 and stem 62 and extend from a first opening 68 in the outer wall of the stem 62 to a second opening 70 in an upper surface of the cap portion 56 that may be aligned with the vent 54 of the funnel 52 when the funnel 52 is attached to the cap portion 56 to form a substantially watertight seal with the ball 58 disposed within the cavity 60.

Configured in this way, two channels are formed in the quick fill cap 50 placing the outside atmosphere in fluid communication with the interior of the tank 16 when the quick fill cap 50 is attached to the fill port 14. The first channel is formed by the funnel 52, the cap 56 and stem 62, and the one-way valve 32 to permit the output stream of liquid 42 discharged from the outlet 40 to flow into the tank 16 while preventing the accumulated liquid 44 from flowing back through the closed end of the one-way valve 32 as previously described. The second channel may be formed by the vent 54 and ball valve cavity 60 that, in the absence of the ball 58, would allow bidirectional flow of air and liquid between the outer atmosphere and the interior of the tank 16. However, the ball 58 may be disposed within the cavity 60 to prevent the accumulated liquid 44 from flowing out of the tank 16 through the cavity 60 and vent 54. The cavity 60 may have an inner diameter that may be larger than the outer diameter of the ball 58 to allow the ball 58 to move between the first opening 68 and the second opening 70. The first opening 68 may be dimensioned such that the ball 58 engages the first opening 68 to prevent the ball 58 from passing through the outer surface of the stem 62. The first opening 68 may be circular such that the ball 58 is seated in the first opening 68 when the ball 58 is disposed thereby or, alternatively, the first opening 68 may be configured such that the ball 58 is not fully seated in the first opening 68 so that air and liquid may be free to pass around the ball 58 when the ball 58 is disposed at the first opening 68. In order to allow the ball 58 to be disposed within the cavity 60, the second opening 70 may be dimensioned such that the ball 58 may freely pass through the second opening 70 when the funnel 52 is not connected to the cap portion 56. In order to retain the ball 58 within the cavity 60 while providing the previously discussed second channel, the vent 54 may be dimensioned such that the ball 58 may not pass through the opening 70 and into the vent 54 when the funnel 52 is attached to the cap portion 56. Further, the vent 54 may be dimensioned such that the ball 58 is engaged by and seated in the vent 54 when the ball 58 is disposed at the second opening 70, thereby allowing the ball 58 and vent 54 to form a substantially airtight and watertight seal.

As the output stream of liquid 42 is discharged into the tank 16 through the quick fill cap 12 by the outlet 40 as shown in FIG. 8, the outlet 40 may be engaged by the inner surface of the funnel 52 to form a substantially airtight and watertight seal. If air is not released from the tank 16, the pressure inside the tank 16 will increase as the accumulated liquid 44 increases and reduces the volume occupiable by the air in the tank 16. As the pressure increases in the tank 16 having the quick fill cap 50 attached to the fill port 14, the air in the tank 16 may enter the cavity 60 through the first opening 68, around the ball 58, out of the cavity through the second opening 70 and through the vent 54 to the outer atmosphere. If the ball 58 is seated in the lower opening 68, a minimum amount of pressure in the tank 16 may be necessary for the air to move the ball 58 out of engagement with the first opening 68. Conversely, if the ball 58 does not seat within the first opening 68, the air may be free to pass into the first opening 68 and around the ball 58 without attaining a minimum pressure necessary to move the ball 58.

Once the tank 16 is filled and the outlet 40 is removed from the funnel 52, the ball 58 may prevent the accumulated liquid 44 from leaking onto the tank 16 through the channel formed by the cavity 60 and vent 54 as illustrated in FIG. 9. When the toy water gun 10 and, consequently, the tank 16 are inverted, the ball 58 may move within the cavity 60 from the first opening 68 to the second opening 70 where the ball 58 is engaged by the vent 54. In order to facilitate a watertight seal between the ball 58 and the vent 54, the funnel 52 may be fabricated from rubber or other resilient or semi-resilient material that will conform to the surface of the ball 58 under the weight of the ball 58 and the liquid 44 accumulated behind the ball 58 in the cavity 60. When the toy water gun 10 is restored to the upright position of FIG. 8, the ball 58 unseats from the vent 54 at the second opening 70 and moves within the cavity 60 downwardly to the first opening 68. While the quick fill cap 50 is illustrated and described herein as having a ball valve for releasing air from the tank 16 while retaining the accumulated water 44 therein, the quick fill cap 50 may incorporate any conventional one-way or check valve, such as a flap valve or the like, which will permit air in the tank 16 to flow freely in one direction out of the quick fill cap 50, in which prevents the accumulated liquid 44 from flowing out of the tank 16 through the same channel.

While the preceding text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

What is claimed is:

1. A quick fill cap for a toy gun capable of discharging an output stream of liquid, the toy gun having a liquid reservoir for storing a quantity of liquid and fill port for depositing liquid in to the liquid reservoir, the quick fill cap comprising:
a cap portion having a throughbore, the cap portion being adapted to demountably attach to the fill port of the toy gun and to form a substantially airtight and watertight seal with the fill port;
a hollow funnel having a lower surface connected to an upper surface of the cap portion such that a substantially airtight and watertight seal is formed between the lower surface of the hollow funnel and the upper surface of the cap portion, the hollow funnel being substantially aligned with the throughbore of the cap, and wherein the hollow funnel is disposed external to the liquid reservoir when the cap portion is demountably attached to the fill port; and
a one-way valve connected to the cap portion proximate an opening of the throughbore opposite the hollow funnel, wherein the one-way valve is disposed on the interior of the liquid reservoir when the cap portion is demountably attached to the fill port, the one-way valve being adapted to allow liquid to flow from the exterior of the liquid reservoir through the channel formed by the hollow funnel and the throughbore of the cap portion and into the reservoir, and to prevent liquid from flowing from the interior of the liquid reservoir through the channel formed by the throughbore of the cap portion and the hollow funnel to the exterior of the reservoir.

2. A quick fill cap as defined in claim 1, wherein the one-way valve comprises a duck bill valve.

3. A quick fill cap as defined in claim 2, wherein the cap portion comprises a stem extending downwardly and defining a portion of the throughbore of the cap portion, wherein a portion of the duck bill valve is disposed on the outer surface of at least a portion of the stem with the inner surface of the portion of the duck bill valve engaging the outer surface of the at least a portion of the stem, the inner surface of the portion of the duck bill valve and the outer surface of the at least a portion of the stem being adapted to form a substantially airtight and watertight seal therebetween.

4. A quick fill cap as defined in claim 1, wherein fill port has a threaded outer surface, the cap portion comprising a treaded inner surface being adapted to engage the threaded outer surface of the fill port and to form a substantially airtight and watertight seal therebetween.

5. A quick fill cap as defined in claim 1, wherein the liquid reservoir may be filled with liquid discharged from an outlet through the fill port, wherein the hollow funnel is fabricated from an elastomeric material, and wherein an inner surface of the hollow funnel may engage an outlet discharging liquid disposed therein to form a substantially airtight and watertight seal therebetween.

6. A quick fill cap as defined in claim 1, further comprising an air release valve having a first opening placing the air release valve in fluid communication with the interior of the liquid reservoir when the cap portion is demountably attached to the fill port and a second opening placing the air release valve in fluid communication with the atmosphere external to the liquid reservoir, wherein the air release valve is open such that air disposed within the liquid reservoir is in fluid communication with the atmosphere external to the liquid reservoir when the toy gun and quick fill cap are disposed in an upright position, and wherein the air release valve is closed to prevent air and water disposed within the liquid reservoir from being communicated to atmosphere external to the liquid reservoir when the toy gun and quick fill cap are disposed in an inverted position.

7. A quick fill cap as defined in claim 6, wherein the air release valve comprises:
a cavity disposed within the cap portion, wherein the first opening is disposed in a first portion of the first opening disposed within the liquid reservoir when the cap portion is demountably attached to the fill port and the second opening is disposed in a second portion of the cap portion in fluid communication with the external atmosphere when the cap portion is demountably attached to the fill port; and
a ball disposed and slidable within the cavity, wherein the ball is disposed proximate the first opening when the toy gun and quick fill cap are disposed in the upright position, and wherein the ball is disposed proximate the second opening when the toy gun and quick fill cap are disposed in the inverted position, the second opening being adapted to engage the ball to form a substantially airtight and watertight seal when the toy gun and quick fill cap are disposed in the inverted position.

8. A quick fill cap as defined in claim 7, wherein the hollow funnel comprises a vent disposed within an outer wall of the hollow funnel and substantially aligned with the second opening of the air release valve, wherein a portion of the vent proximate the second opening of the air release valve engages the ball when the toy gun and quick fill cap are disposed in the inverted position with the portion of the vent being adapted to engage the ball to form a substantially airtight and watertight seal therebetween.

9. A quick fill cap for a toy gun capable of discharging an output stream of liquid, the toy gun having a liquid reservoir for storing a quantity of liquid and fill port for depositing liquid in to the liquid reservoir, the quick fill cap comprising:
a cap portion having a throughbore, the cap portion being adapted to demountably attach to the fill port of the toy gun and to form a substantially airtight and watertight seal with the fill port;
a hollow funnel having a lower surface connected to an upper surface of the cap portion such that a substantially airtight and watertight seal is formed between the lower surface of the hollow funnel and the upper surface of the cap portion, the hollow funnel being substantially aligned with the throughbore of the cap, and wherein the hollow funnel is disposed external to the liquid reservoir when the cap portion is demountably attached to the fill port; a one-way valve connected to the cap portion proximate an opening of the throughbore opposite the hollow funnel, wherein the one-way valve is disposed on the interior of the liquid reservoir when the cap portion is demountably attached to the fill port, the one-way valve being adapted to allow liquid to flow from the exterior of the liquid reservoir through the channel formed by the hollow funnel and the throughbore of the cap portion and into the reservoir, and to prevent liquid from flowing from the interior of the liquid reservoir through the channel formed by the throughbore of the cap portion and the hollow funnel to the exterior of the reservoir; and
an air release valve having a first opening placing the air release valve in fluid communication with the interior of the liquid reservoir when the cap portion is demountably attached to the fill port and a second opening placing the air release valve in fluid communication with the atmosphere external to the liquid reservoir, wherein the air release valve is open such that air disposed within the liquid reservoir is in fluid communication with the atmosphere external to the liquid reservoir when the toy gun and quick fill cap are disposed in an upright position, and wherein the air release valve is closed to prevent air and water disposed within the liquid reservoir from being communicated to atmosphere external to the liquid reservoir when the toy gun and quick fill cap are disposed in an inverted position.

10. A quick fill cap as defined in claim 9, wherein the one-way valve comprises a duck bill valve.

11. A quick fill cap as defined in claim 10, wherein the cap portion comprises a stem extending downwardly and defining a portion of the throughbore of the cap portion, wherein a portion of the duck bill valve is disposed on the outer surface of at least a portion of the stem with the inner surface of the portion of the duck bill valve engaging the outer surface of the at least a portion of the stem, the inner surface of the portion of the duck bill valve and the outer surface of the at least a portion of the stem being adapted to form a substantially airtight and watertight seal therebetween.

12. A quick fill cap as defined in claim 9, wherein fill port has a threaded outer surface, the cap portion comprising a treaded inner surface being adapted to engage the threaded outer surface of the fill port and to form a substantially airtight and watertight seal therebetween.

13. A quick fill cap as defined in claim 9, wherein the liquid reservoir may be filled with liquid discharged from an outlet through the fill port, wherein the hollow funnel is fabricated from an elastomeric material, and wherein an inner surface of the hollow funnel may engage an outlet discharging liquid disposed therein to form a substantially airtight and watertight seal therebetween.

14. A quick fill cap as defined in claim 9, wherein the air release valve comprises:
a cavity disposed within the cap portion, wherein the first opening is disposed in a first portion of the first opening disposed within the liquid reservoir when the cap portion is demountably attached to the fill port and the second opening is disposed in a second portion of the cap portion in fluid communication with the external atmosphere when the cap portion is demountably attached to the fill port; and
a ball disposed and slidable within the cavity, wherein the ball is disposed proximate the first opening when the toy gun and quick fill cap are disposed in the upright position, and wherein the ball is disposed proximate the second opening when the toy gun and quick fill cap are disposed in the inverted position, the second opening being adapted to engage the ball to form a substantially airtight and watertight seal when the toy gun and quick fill cap are disposed in the inverted position.

15. A quick fill cap as defined in claim 14, wherein the hollow funnel comprises a vent disposed within an outer wall of the hollow funnel and substantially aligned with the second opening of the air release valve, wherein a portion of the vent proximate the second opening of the air release valve engages the ball when the toy gun and quick fill cap are disposed in the inverted position with the portion of the vent being adapted to engage the ball to form a substantially airtight and watertight seal therebetween.
